(19) United States
(12) Patent Application Publication
(10) Pub. No.: US 2012/0115988 A1
(43) Pub. Date: May 10, 2012

(54) CATALYSIS OF EPOXY RESIN FORMULATIONS HAVING SPARINGLY SOLUBLE CATALYSTS

(75) Inventors: Emmanouil Spyrou, Schermbeck (DE); Rainer Lomölder, Muenster (DE); Susanne Kreischer, Herten (DE); Andrea Vöcker, Ahaus (DE)

(73) Assignee: EVONIK DEGUSSA GmbH, Essen (DE)

(21) Appl. No.: 13/383,485

(22) PCT Filed: Apr. 29, 2010
(86) PCT No.: PCT/EP2010/055793

§ 371 Date: Jan. 11, 2012

(30) Foreign Application Priority Data
Jul. 20, 2009 (DE) 10 2009 027 825.7

(51) Int. Cl. C08L 63/02; C09D 163/02; C09J 163/02; C08G 59/68

(52) U.S. Cl. 523/400; 528/94

(57) ABSTRACT

The present invention relates to epoxy resin formulations having a specific sparingly soluble catalyst mixture for enhancing reactivity.

The present invention relates to epoxy resin formulations having a specific sparingly soluble catalyst mixture to increase the reactivity.

The use of latent hardeners, e.g. dicyandiamide, for curing epoxy resins is known (e.g. U.S. Pat. No. 2,637,715 or U.S. Pat. No. 3,391,113). The advantages of dicyandiamide are, in particular, the toxicological acceptability and the chemically inert behavior which leads to good storage stability.

However, their slow reactivity every now and again gives an incentive to develop catalysts, known as accelerators, in order to increase this reactivity so that curing can take place even at low temperatures. This saves energy, increases the cycle time and in particular does not harm temperature-sensitive substrates. A whole series of different substances have been described as accelerators, e.g. tertiary amines, imidazoles, substituted ureas (urons) and many more.

Imidazole-blocked have also already been proposed as catalysts (U.S. Pat. No. 4,335,228). Owing to the good solubility of this product, however, undesirable reactions can occur during storage.

Despite the large number of systems used, there is still a need for catalysts which increase the reactivity but do not significantly decrease the storage stability.

It was therefore an object of the present invention to provide accelerators for epoxy resin systems which do not have the abovementioned disadvantages but instead have a high reactivity at the curing temperature and also good storage stability below the curing temperature.

It has surprisingly been found that reactive epoxy resin systems containing latent hardeners have an advantageous balance of reactivity and storage stability when sparingly soluble ureas of isocyanurates and heterocycles and further polyamines or polyols are used as accelerator.

The invention provides reactive compositions containing essentially

A) at least one epoxy resin;
B) at least one latent hardener which in the uncatalyzed reaction with component A) has a maximum of the exothermic reaction peak in the DSC at temperatures above 150° C.;
C) at least one accelerator comprising the reaction product of
C1) at least one NCO-containing component and
C2) one or more N-, S- and/or P-containing heterocycles and
C3) one or more polyamines and/or polyols;
D) optionally other conventional additives.

Epoxy resins A) generally consist of glycidyl ethers based on bisphenols of type A or F or based on resorcinol or tetrakisphenylolethane or phenol/cresol-formaldehyde novolaks, as are described, for example, in Lackharze, Stoye/Freitag, Carl Hanser Verlag, Munich Vienna, 1996 on pp. 230 to 280. Other epoxy resins mentioned there are naturally also possible. Examples which may be mentioned are: EPIKOTE 828, EPIKOTE 834, EPIKOTE 835, EPIKOTE 836, EPIKOTE 1001, EPIKOTE 1002, EPIKOTE 154, EPIKOTE 164, EPON SU-8 (EPIKOTE and EPON are trade names of products of Resolution Performance Products).

As epoxy resin component A), preference is given to using polyepoxides based on bisphenol A diglycidyl ether, bisphenol F diglycidyl ether or cycloaliphatic types.

Preference is given to using epoxy resins A) selected from the group consisting of epoxy resins A) based on bisphenol A diglycidyl ether, epoxy resins based on bisphenol F diglycidyl ether and cycloaliphatic types such as 3,4-epoxycyclohexyl-epoxyethane or 3,4-epoxycyclohexylmethyl 3,4-epoxycyclohexanecarboxylate in curable compositions according to the invention, with bisphenol A-based epoxy resins and bisphenol F-based epoxy resins being particularly preferred. According to the invention, it is also possible to use mixture of epoxy resins as component A).

Latent hardeners B) (see also EP 682 053) either have quite a low reactivity, in particular at low temperatures, or else are sparingly soluble, frequently even both. According to the invention, suitable latent hardeners are those which, in the uncatalyzed reaction (curing) with the component A), have the maximum of the exothermic reaction peak at temperatures above 150° C., with those having the maximum of the exothermic reaction peak at temperatures above 170° C. being particularly suitable (measured by means of DSC, commencing at ambient temperature (usually at 25° C.), heating rate 10 K/min, end point 250° C.). Possible hardeners are the hardeners described in U.S. Pat. No. 4,859,761 or EP 306 451. Preference is given to using substituted guanidines and aromatic amines. The most frequent representative of substituted guanidines is dicyandiamide. Other substituted guanidines can also be used, e.g. benzoguanamine or o-tolylbiguanidine. The most frequent representative of aromatic amines is bis(4-aminophenyl) sulfone. Other aromatic diamines are also possible, e.g. bis(3-aminophenyl) sulfone, 4,4′-methylenediamine, 1,2- or 1,3- or 1,4-benzenediamines, bis(4-aminophenyl)-1,4-diisopropylbenzene (e.g. EPON 1061 from Shell), bis(4-amino-3,5-dimethylphenyl)-1,4-diisopropylbenzene (e.g. EPON 1062 from Shell), bis(aminophenyl)ether, diaminobenzophenones, 2,6-diaminopyridine, 2,4-toluenediamine, diaminodiphenylpropanes, 1,5-diaminonaphthalene, xylenediamines, 1,1-bis-4-aminophenylcyclohexane, methylenebis(2,6-diethylaniline) (e.g. LONZACURE M-DEA from Lonza), methylenebis(2-isopropyl-6-methylaniline) (e.g. LONZACURE M-MIPA from Lonza), methylenebis(2,6-diisopropylaniline) (e.g. LONZACURE M-DIPA from Lonza), 4-aminodiphenylamine, diethyltoluenediamine, phenyl-4,6-diaminotriazine, lauryl-4,6-diaminotriazine.

Further suitable latent hardeners are N-acylimidazoles such as 1-(2′,4′,6′-trimethylbenzoyl)-2-phenylimidazole or 1-benzoyl-2-isopropylimidazole. Such compounds are described, for example in U.S. Pat. No. 4,436,892 and U.S. Pat. No. 4,587,311.

Other suitable hardeners are metal salt complexes of imidazoles, as are described, for example, in U.S. Pat. No. 3,678,007 or U.S. Pat. No. 3,677,978, carboxylic hydrazides such as adipic dihydrazide, isophthalic dihydrazide or anthranilic hydrazide, triazine derivatives such as 2-phenyl-4,6-diamino-s-triazine (benzoguanamine) or 2-lauryl-4,6-diamino-s-triazine (lauroguanamine) and also melamine and derivatives thereof. The latter compounds are described, for example, in U.S. Pat. No. 3,030,247.

Cyanoacetyl compounds as described, for example, in U.S. Pat. No. 4,283,520, for example neopentyl glycol biscyanoacetate, N-isobutylcyanoacetamide, 1,6-hexamethylene biscyanoacetate or 1,4-cyclohexanedimethanol biscyanoacetate, are also suitable as latent hardeners.

Further suitable latent hardeners are N-cyanoacylamide compounds such as N,N′-dicyanoadipic diamide. Such compounds are described, for example, in U.S. Pat. No. 4,529,821, U.S. Pat. No. 4,550,203 and U.S. Pat. No. 4,618,712.

Other suitable latent hardeners are the acylthiopropylphenols described in U.S. Pat. No. 4,694,096 and the urea derivatives, e.g. toluene-2,4-bis(N,N-dimethylcarbamide) disclosed in U.S. Pat. No. 3,386,955.

It is naturally also possible to use aliphatic or cycloaliphatic diamines and polyamines, if they are sufficiently unreactive. An example which may be mentioned here is polyetheramines, e.g. JEFFAMINE 230 and 400. The use of aliphatic or cycloaliphatic diamines or polyamines whose reactivity has been reduced by steric and/or electronic influencing factors or/and are sparingly soluble or have a high melting point, e.g. JEFFLINK 754 (Huntsman) or CLEARLINK 1000 (Dorf Ketal) is also conceivable.

It is naturally also possible to use mixtures of latent hardeners. Preference is given to using dicyandiamide and bis(4-aminophenyl) sulfone.

The ratio of epoxy resin to the latent hardener can be varied over a wide range. However, it has been found to be advantageous to use the latent hardener in an amount of about 1-15% by weight based on the epoxy resin, preferably 4-10% by weight.

The NCO-containing component C1) used according to the invention can comprise any aromatic, aliphatic, cycloaliphatic and/or (cyclo)aliphatic diisocyanates and/or polyisocyanates.

As aromatic diisocyanates or polyisocyanates, it is in principle possible to use all known compounds. Particularly suitable compounds are phenylene 1,3- and 1,4-diisocyanate, naphthylene 1,5-diisocyanate, tolidine diisocyanate, toluoylene 2,6-diisocyanate, toluoylene 2,4-diisocyanate (2,4-TDI), diphenylmethane 2,4′-diisocyanate (2,4′-MDI), diphenylmethane 4,4′-diisocyanate, mixtures of monomeric diphenylmethane diisocyanates (MDI) and oligomeric diphenylmethane diisocyanates (polymeric MDI), xylylene diisocyanate, tetramethylxylylene diisocyanate and triisocyanatotoluene.

Suitable aliphatic diisocyanates or polyisocyanates advantageously have from 3 to 16 carbon atoms, preferably from 4 to 12 carbon atoms, in the linear or branched alkylene radical and suitable cycloaliphatic or (cyclo)aliphatic diisocyanates advantageously have from 4 to 18 carbon atoms, preferably from 6 to 15 carbon atoms, in the cycloalkylene radical. A person skilled in the art will understand (cyclo)aliphatic diisocyanates to be diisocyanates having both cyclically and aliphatically bound NCO groups, as is the case for, for example, isophorone diisocyanate. In contrast, cycloaliphatic diisocyanates are diisocyanates which have only NCO groups bound directly to the cycloaliphatic ring, e.g. H₁₂MDI. Examples are cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate, hexane diisocyanate, heptane diisocyanate, octane diisocyanate, nonane diisocyanate, nonane triisocyanate, e.g. 4-isocyanatomethyl-1,8-octane diisocyanate (TIN), decane diisocyanate and decane triisocyanate, undecane diisocyanate and undecane triisocyanate, dodecane diisocyanate and dodecane triisocyanate.

Preference is given to isophorone diisocyanate (IPDI), hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI). Particular preference is given to using IPDI, HDI, TMDI and H₁₂MDI.

Very particular preference is given to using the isocyanurates based on IPDI and HDI as component C1). These are commercially available as, for example, DESMODUR N3300 (isocyanurate derived from HDI, Bayer AG) and VESTANAT T1890 (isocyanurate derived from IPDI, Evonik-Degussa GmbH).

Further suitable diisocyanates are 4-methylcyclohexane 1,3-diisocyanate, 2-butyl-2-ethylpentamethylene diisocyanate, 3(4)-isocyanatomethyl-1-methyl-cyclohexyl isocyanate, 2-isocyanatopropylcyclohexyl isocyanate, 2,4′-methylenebis(cyclohexyl) diisocyanate, 1,4-diisocyanato-4-methylpentane.

It is of course also possible to use mixtures of all the diisocyanates and polyisocyanates mentioned.

Furthermore, preference is given to using oligoisocyanates or polyisocyanates which can be prepared from the abovementioned diisocyanates or polyisocyanates or mixtures thereof by coupling by means of urethane, allophanate, urea, biuret, uretdione, amide, isocyanurate, carbodiimide, uretonimine, oxadiazinetrione or iminooxadiazinedione structures. Isocyanurates, in particular those derived from IPDI and HDI, are particularly suitable.

Suitable heterocycles C2) are all nitrogen-, sulfur- or phosphorus-containing ring systems having preferably from 5 to 7 ring atoms and at least one hydrogen which is reactive toward isocyanates, e.g. aziridine, pyrrole, imidazole, pyrazole, triazole, azepine and indole. Preference is given to using imidazole, pyrazole and triazole. Alkyl-substituted heterocycles, preferably 3,5-dimethylpyrazole, are also suitable.

As polyamines or polyols C3), it is possible to use all monomers, oligomers or polymers having at least two hydrogen atoms selected from the group of amino groups (NH or NH₂) and/or alcohol groups which are reactive toward isocyanates. As examples which are suitable for the purposes of the invention, mention may be made of ethylenediamine, diethylenetriamine, triethylenetetramine, monoethanolamine, diethanolamine, diisopropanolamine, propylenediamine, hexamethylenediamine, trimethylhexamethylenediamine, isophoronediamine, dicyclohexylmethylenediamine, methyldiphenyldiamine, toluenediamine, ethylene glycol, neopentyl glycol, trimethylolpropane, propanediol, butanediol, hexanediol, polyether dialcohols, polyether trialcohols, polyether diamines and/or polyether triamines. Preference is given to using monomeric polyamines, preferably ethylenediamine and diethylenetriamine.

The reaction between C1), C2) and C3) can be carried out in conventional apparatuses, e.g. in stirred vessels, high-speed mixers, high-power kneaders, static mixers or extruders, with or without the presence of solvents. For this purpose, C1) is generally placed in the apparatus, brought to a suitable temperature in the range from RT to 180° C. and admixed in succession or simultaneously with C2) and C3) until the reaction has proceeded to completion. If a solvent is present, this is then either removed by distillation or filtered off. If the reaction has been carried out without solvent, the mixture is optionally allowed to cool before it is in both cases milled and sieved.

The ratio of C1), C2) and C3) is selected so that the sum of the reactive hydrogen atoms H correspond approximately to the NCO equivalents, i.e. H:NCO=1.5:1 to 1:1.5, preferably from 1.1:1 to 1:1.1 and particularly preferably 1:1.

The incorporation of the accelerator C) into the total formulation or else into part of the total formulation can be effected by simple stirring or else by dispersion in suitable dispersing apparatuses, optionally using dispersants, e.g. TEGO Dispers (Evonik Degussa GmbH) additives.

Conventional additives D) can be solvents, pigments, leveling agents, matting agents and also further conventional accelerators, e.g. urons or imidazoles. The amount of these additives can vary greatly depending on the application.

The present invention also provides for the use of the reactive compositions claimed in, for example, fiber composites, adhesives, electrolaminates and powder coatings and also articles which contain a reactive composition according to the invention.

To produce the composition of the invention, the components are homogenized in suitable apparatuses, e.g. in stirred vessels, high-speed mixers, high-speed kneaders, static mixers or extruders, generally at elevated temperatures (70-130° C.). In the case of powder coating applications, the cooled mixture is crushed, milled and sieved.

The composition of the invention has a particularly good storage stability; in particular, the viscosity increase after 8 hours at 60° C. is not more than 50% of the initial value. In addition, the composition of the invention is, owing to the component C), i.e. the accelerator, which is present according to the invention, at least so reactive that complete crosslinking has taken place after 30 minutes at 140° C. (demonstrated by a flexible and chemicals-resistant coating film).

Depending on the field of application, the reactive composition can be applied in any way, e.g. by means of a doctor blade, painted, sprinkled, squirted, sprayed, cast, flooded or impregnated.

In the case of powder coatings, for example, the sieved powder is electrostatically charged and then sprayed onto the substrate to be coated.

After application of the reactive composition to the substrate, curing can be carried out at elevated temperature in one or more stages, with or without superatmospheric pressure. The curing temperature is in the range from 70 to 220° C., usually from 120 to 180° C. The curing time is in the range from 1 minute to a number of hours, usually from 5 minutes to 30 minutes, depending on reactivity and temperature.

The invention is illustrated below with the aid of examples. Alternative embodiments of the present invention can be derived in an analogous way.

### EXAMPLES

| Starting material | Product description, manufacturer |
|---|---|
| EPIKOTE 828 | Component A) diglycidyl ether of |
| | bisphenol A, Resolution |
| DYHARD SF 100 | Component B) dicyandiamide, Evonik |
| | Degussa GmbH |
| VESTANAT T1890 | Component C1) isocyanurate of IPDI, |
| | Evonik Degussa GmbH |
| Imidazole | C2) Aldrich |
| Ethylenediamine | C3) Aldrich |

### Preparation of the Catalyst:

220 g of VESTANAT T1890 are dissolved in 600 ml of acetone. 32.5 g of imidazole are added a little at a time. After the addition is complete, the mixture is refluxed for 10 hours. It is then cooled to room temperature and a solution of 11 g of ethylenediamine in 100 ml of acetone is then added dropwise. The precipitate formed is filtered off and dried to constant weight at 50° C. in a vacuum drying oven. The resulting white solid (207 g) has a melting point of >250° C. It is milled in a powder coating mill (from Fritsch) and sieved to <28 μm (Retsch sieving machine).

### Production of the Reactive Formulation (Experiment 1)

3.1 g of the catalyst are dispersed in 43.3 g of EPIKOTE 828 with water cooling for 30 minutes at 3000 rpm and then for a further 30 minutes at 9000 rpm by means of a high-speed stirrer. During this time, it is ensured that the temperature does not rise above 50° C. A further 56.7 g of EPIKOTE and 6.0 g of DYHARD SF 100 are added to this mixture and the mixture is stirred for another 10 minutes at 9000 rpm.

As Comparative Experiment (2*), the Same Mixture is Produced without a Catalyst.

Then testing for storage stability is carried out by means of a viscosity measurement and for reactivity by means of curing in a coating.

### Composition

All figures in % by weight

| | 1 | 2* |
|---|---|---|
| EPIKOTE 828 | 92 | 95 |
| DYHARD SF 100 | 5 | 5 |
| CATALYST | 3 | |

*Comparative experiment which is not according to the invention

### a) Storage Stability

| | Viscosity at 23° C. after storage in a convection | | | | |
|---|---|---|---|---|---|
| | drying oven [Pas] | | | | |
| | | 2 h | 4 h | 6 h | 8 h 60° C. (increase |
| No.: | Start | 60° C. | 60° C. | 60° C. | compared to start) |
| 1 | 25 | 26 | 28 | 29 | 31 (24%) |
| 2* | 22 | 23 | 23 | 23 | 23 (5%) |

*Comparative experiment which is not according to the invention
The compositions 1 and 2 are storage-stable (viscosity increase after 8 h at 60° C. not greater than 50%).

### b) Reactivity

The compositions 1 and 2* were applied by doctor blade to steel plates and cured at 140° C. for 30 minutes in a convection oven. This gave the following coating data:

| No. | 1 | 2* |
|---|---|---|
| Layer thickness [μm] | 49-67 | 40-51 |
| Erichsen cupping [mm] | 6.0 | cannot be determined |
| Ball impact | 40/<10 | cannot be determined |
| dir/indir [inch*lbs] | | |
| Pendulum hardness [s] | 223 | cannot be determined |
| MEK test (double strokes) | >100 | cannot be determined |
| Remark | cured | film sticks, not cured! |

*Comparative experiment which is not according to the invention

Erichsen cupping in accordance with DIN 53 156
Ball impact in accordance with ASTM D 2794-93
Pendulum hardness in accordance with DIN 53 157
Cross-cut in accordance with DIN 53 151
MEK test: methyl ethyl ketone resistance test by rubbing with a cotton wool ball impregnated with MEK under a 1 kg load until the layer dissolves (double strokes are counted).

The composition 1 cured: the flexibility (Erichsen cupping>5 mm, dir. ball impact>10 inch*lbs) is satisfactory and the resistance to chemicals (MEK test>100 double strokes) is sufficient.

The composition 2 did not cure. Owing to the stickiness it could not be tested.

Only the composition 1 according to the invention is both storage-stable and sufficiently reactive.

1. A reactive composition, comprising:
A) an epoxy resin;
B) a latent hardener, which in an uncatalyzed reaction with the epoxy resin A) has a maximum of an exothermic reaction peak in the DSC at temperatures above 150° C.; and
C) an accelerator comprising a reaction product of
C1) at least one NCO-containing component, and
C2) at least one heterocycle comprising N, S, P, or a combination thereof, and
C3) at least one polyamine, polyol, or combination thereof.

2. The reactive composition of claim 1, further comprising:
D) an additive.

3. The reactive composition of claim 1, wherein the epoxy resin A) comprises a glycidyl ether based on bisphenols of type A or F, resorcinol, tetrakisphenylolethane, phenol/cresol-formaldehyde novolaks, or a combination thereof.

4. The reactive composition of claim 1, wherein the epoxy resin A) is based on bisphenol A diglycidyl ether, bisphenol F diglycidyl ether, a cycloaliphatic ether, or a combination thereof.

5. The reactive composition of claim 1, wherein the latent hardener B) comprises a substituted guanidine.

6. The reactive composition of claim 1, wherein the latent hardener B) is at least one selected from the group consisting of bis(3-aminophenyl) sulfone, 4,4′-methylenediamine, a 1,2-benzenediamine, a 1,3-benzenediamine, a 1,4-benzenediamine, bis(4-aminophenyl)-1,4-diisopropylbenzene, bis(4-amino-3,5-dimethylphenyl)-1,4-diisopropylbenzene, bis(aminophenyl)ether, a diaminobenzophenone, 2,6-diaminopyridine, 2,4-toluenediamine, a diaminodiphenylpropane, 1,5-diaminonaphthalene, a xylenediamine, 1,1-bis-4-aminophenylcyclohexane, methylenebis(2,6-diethylaniline), methylenebis(2-isopropyl-6-methylaniline), methylenebis(2,6-diisopropylaniline), 4-aminodiphenylamine, diethyltoluenediamine, phenyl-4,6-diaminotriazine, and lauryl-4,6-diaminotriazine.

7. The reactive composition of claim 1, wherein the NCO-containing component is at least one selected from the group consisting of isophorone diisocyanate (IPDI), hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI), and norbornane diisocyanate (NBDI).

8. The reactive composition of claim 1, wherein the NCO-containing component is at least one selected from the group consisting of isophorone diisocyanate (IPDI), hexamethylene diisocyanate (HDI), 2,2,4-trimethylhexamethylene diisocyanate/2,4,4-trimethylhexamethylene diisocyanate (TMDI), and diisocyanatodicyclohexylmethane (H₁₂MDI).

9. The reactive composition of claim 1, wherein the NCO-containing component comprises an isocyanate.

10. The reactive composition of claim 1, wherein the heterocycle C2) is at least one selected from the group consisting of aziridine, pyrrole, imidazole, pyrazole, triazole, azepine, and indole.

11. The reactive composition of claim 1, wherein the heterocycle C2) is at least one selected from the group consisting of imidazole, pyrazole, and triazole.

12. The reactive composition of claim 1, wherein the polyamine, polyol, or combination thereof C3) is at least one selected from the group consisting of ethylenediamine, diethylenetriamine, triethylenetetramine, monoethanolamine, diethanolamine, diisopropanolamine, propylenediamine, hexamethylenediamine, trimethylhexamethylenediamine, isophoronediamine, dicyclohexylmethylenediamine, methyldiphenyldiamine, toluenediamine, ethylene glycol, neopentyl glycol, trimethylolpropane, propanediol, butanediol, hexanediol, a polyether dialcohol, a polyether trialcohol, a polyether diamine, a polyether triamine.

13. The reactive composition of claim 1, wherein the polyamine, polyol, or combination thereof C3) consists of ethylenediamine and diethylenetriamine.

14. The reactive composition of claim 1, wherein a ratio of the NCO-containing component C1), the heterocycle C2) and the polyamine, polyol, or combination thereof C3) is such that a sum of reactive hydrogen atoms corresponds approximately to a sum of NCO equivalents.

15. The reactive composition of claim 1, wherein a ratio of H:NCO=1.5:1 to 1:1.5.

16. The reactive composition of claim 2, wherein the additive is at least one selected from the group consisting of a solvent, a pigment, a leveling agent, a matting agent, and an accelerator.

17. The reactive composition of claim 1 which is storage-stable with a viscosity increase after 8 hours at 60° C. of not more than 50% of an initial value.

18. The reactive composition of claim 1, wherein the composition is at least so reactive that complete crosslinking has taken place after 30 minutes at 140° C.

19. A process for producing the reactive composition of claim 1, the process comprising homogenizing at least one epoxy resin A), at least one latent hardener B), and at least one accelerator C).

20. A material comprising the reactive composition of claim 1, wherein the material is at least one selected from the group consisting of a fiber composite, an adhesive, an electrolaminate, and a powder coating.

21. (canceled)
